(19) United States
(12) Patent Application Publication
(10) Pub. No.: US 2025/0006402 A1
(43) Pub. Date: Jan. 2, 2025

(54) FLEXIBLE AND STRETCHABLE RIBBON CABLES

(71) Applicant: Board of Regents, The University of Texas System, Austin, TX (US)

(72) Inventors: Negar Geramifard, Oakland, CA (US); Behnoush Dousti, Milpitas, CA (US); Stuart Cogan, Dallas, TX (US)

(21) Appl. No.: 18/757,023

(22) Filed: Jun. 27, 2024

Related U.S. Application Data
(60) Provisional application No. 63/510,590, filed on Jun. 27, 2023.

(51) Int. Cl. H01B 7/06; H01B 7/04; H01B 7/08

(52) U.S. Cl. CPC H01B 7/06; H01B 7/04; H01B 7/08

(57) ABSTRACT

A ribbon cable including a ribbon cable body in a longitudinal (x), lateral (y) and transversal (z) dimensional axis system including a length down a central longitudinal (x) axis, where the ribbon cable body includes at least one stretchable electrically conductive material portion along at least a portion of the length, where the stretchable electrically conductive material portion is oriented in a substantially flat accordion pattern in an longitudinal (x)/lateral (y) plane down the central axis, where the stretchable electrically conductive material portion is capable of re-orienting out of the longitudinal (x)/lateral (y) plane into the traversal (z) dimension when stretched in the longitudinal (x)/lateral (y) plane.

.

### CROSS REFERENCE TO RELATED APPLICATION

This application claims priority under 35 U.S.C. § 119(e) to U.S. Patent Application No. 63/510,590 entitled “FLEXIBLE AND STRETCHABLE RIBBON CABLES,” by Negar GERAMIFARD et al., filed Jun. 27, 2023, which is assigned to the current assignee hereof and incorporated herein by reference in its entirety.

### STATEMENT OF GOVERNMENT SUPPORT

This invention was made with government support under grant no. R01 NS104344 awarded by the National Institutes of Health. The government has certain rights in the invention.

### FIELD OF THE DISCLOSURE

The present disclosure relates to ribbon cables and in particular ribbon cables for implantable neural electrodes.

### RELATED ART

A neural interface device such as microelectrode arrays (MEAs) play a significant role in development of clinical brain-machine interfaces and neuroprosthetic devices aimed to restore motor function in paralyzed patients [1,2]. Penetrable MEAs such as intracortical arrays with high number recording sites would provide higher spatial and temporal resolutions which are crucial factors for progress in brain computation modeling and provide faster and better communications between individuals and external environment [3]. Despite all these advancements in the neural interface field, the technological challenges to develop chronically stable bioelectronic systems that are functional in vivo still remain. Mechanical breakage of electrodes and traumatic tissue damage resulting from implantation are two common failure modes of neural electrodes [4,5]. Penetrable neural electrodes are usually hard tethered to the skull with a relatively stiff wire bundle through an anchored connector, causing an adverse micromotion from vascular dilation with each breathing and heartbeat, which contributes to the tissue inflammatory response [4-7], breakage in electrode probes, or unintended extraction of probe from tissue. Increasing the number of electrode channels in the MEAs would be even more complicated, as the thickness and stiffness of wire bundles required to connect MEAs to the external hardware would be increased significantly. Alternatives to mitigate these issues are directed towards using engineering designs and novel architectures to fabricate flexible and stretchable interconnects known as ribbon cables that provide electrical connections between the implantable electronics and external circuitry [8-10]. These lightweight and flexible ribbon cables are expected to provide high dense electrical traces without a significant increase in the total stiffness of the structure, facilitate the microelectrode implantation procedure, and reduce the inflammation response caused by tethering force or micromotions in an in vivo environment and therefore sustain the stability of neural signals over their long-term applications [11-13]. Common polymeric materials used as a substrate in a flexible bioelectronic field include polydimethylsiloxane (PDMS), Parylene-C and polyimide (PI) due to their biocompatibility and tunable mechanical strengths [14-19]. While PDMS is widely used as a sealing material in wire bundles and flexible ribbon cables it is not amendable for practical applications due to the bulkiness of the final structure, manual fabrication, and labor-intensive assembly. On the other hand, Parylene-C and PI's reliable encapsulation properties and more compatibility with complementary metal-oxide-semiconductor (CMOS) microfabrication processing offer large scale repeatable manufacturing and high-resolution feature size, suitable for integration to MEAs [16]. In these cases, PI provides higher tensile strength, higher bendability for comparable thickness, and less thermal expansion coefficient [21, 22]. Regardless of the beneficial characteristics of these compliant materials, polymers are susceptible to fluid absorption and swelling which may lead to interfacial delamination [23-25]. Thus, proper encapsulation strategies are key for reliable and long-term performance of implantable bioelectronics, specifically neural interface devices. Common dielectric materials used as encapsulation layers in electronics include inorganic materials such as silicon oxide (SiO₂), silicon nitride, and amorphous silicon carbide (a-SiC), however, plasma-enhanced chemical vapor deposition (PECVD) SiO₂ and SiNₓ have a high dissolution rate of about 0.1-1 nm/day in an aqueous and biological environment which make them prone to damage and less suitable for chronic bioelectronic applications. E. Song has shown that use of bilayer thermally grown SiO₂ and low pressure chemical vapor deposition (LPCVD) SiNₓ would drastically increase the long-term encapsulation properties of bioelectronics by reducing dissolution rate and providing ion barrier properties, however, this process requires a sophisticated transferring layer method and is not mostly compatible to microfabrication techniques. Alternatively, a-SiC can be used as a reliable encapsulation layer in a bioelectronic system owing to its chemical inertness and low dissolution rate in a biological environment [27]. A-SiC coatings have also shown to improve biocompatibility of implantable devices by reducing the foreign body response accumulated around neural interfaces [28]. Despite all these characteristics, such inorganic dielectric materials are mainly brittle and suffer from lack of mechanical stability, specifically, tensile and bending strength. Thus, various strategies such as tuning geometries and engineering designs are needed to reduce the stress and localize strains to improve extrinsic flexibility and extensibility.

### BRIEF DESCRIPTION OF THE DRAWINGS

Embodiments are illustrated by way of example and are not limited in the accompanying figures.

FIG. 1A includes a ribbon cable with two strips and 16 metal traces in accordance with an embodiment;

FIG. 1B includes a zoomed in optical image of a ribbon-MEA side with a perforated grid and gold for a ribbon cable in accordance with an embodiment;

FIG. 1C includes an optical image of a MEA electrically connected to a MEA using screen printing method for a ribbon cable in accordance with an embodiment;

FIG. 1D includes an SEM image of a MEA electrically connected to a MEA using screen printing method for a ribbon cable in accordance with an embodiment;

FIG. 1E includes an image of a ribbon cable testing structure with a stretchable accordion pattern with a serpentine trace in accordance with an embodiment;

FIG. 1F includes an image of a ribbon cable testing structure with a stretchable accordion pattern with a straight trace in accordance with an embodiment;

FIG. 2A includes a schematic of the fabrication process for a ribbon cable in accordance with an embodiment;

FIG. 2B includes a cross-sectional view of a ribbon cable in accordance with an embodiment;

FIG. 2C includes a schematic of the assembly process using the print screen of silver epoxy followed by encapsulation in medical grade epoxy for a ribbon cable in accordance with an embodiment;

FIG. 3A includes a representative chronoamperometry measurement during a tensile extension of an accordion stretchable ribbon cable according to an embodiment;

FIG. 3B includes a representative chronoamperometry measurement during a tensile extension of a non-stretchable striped ribbon cable with serpentine traces;

FIG. 3C includes a representative chronoamperometry measurement during a tensile extension of a non-stretchable striped ribbon cable with straight traces;

FIG. 4A includes a graph of resistance changes versus elongation at various lengths and back to an initial length with an insert plot of IV response during each elongation of a ribbon cable in accordance with an embodiment;

FIG. 4B includes a digital image of a stretchable ribbon cable under various extensions in accordance with an embodiment;

FIG. 5A includes a Bode plot of a ribbon cable under stretching for 50% of the initial length over 50,000 cycles over a frequency range of 10 mHz to 100 kHz in accordance with an embodiment;

FIG. 5B includes a graph of the average impedance modulus at three frequencies of 10000 Hz, 1 Hz, and 0.1 Hz cycled up to 15 k (mean+sd, n=3 devices with 21 traces) of a ribbon cable within an assembly in accordance with an embodiment;

FIG. 6A includes a strain distribution profile using COMSOL Multiphysics for a 5 mm extension, a 10 mm extension, a 15 mm extension, and a 30 mm extension for ribbon cable within an assembly in accordance with an embodiment;

FIG. 6B includes a stress distribution profile using COMSOL Multiphysics for a 5 mm extension, a 10 mm extension, a 15 mm extension, and a 30 mm extension for ribbon cable within an assembly in accordance with an embodiment;

FIG. 7A includes an optical image of a ribbon cable in accordance with an embodiment wrapped around rods of 1.2 mm, 200 μm, and 100 μm diameters in accordance with an embodiment;

FIG. 7B includes a graph of an impedance modulus of 3 ribbon cables in accordance with an embodiment wrapped around rods of different diameters over a frequency range of 0.1 mHz to 100,000 Hz in comparison to their initial state and when released back to their initial state in accordance with an embodiment;

FIG. 7C includes an IV curve of a ribbon cable in accordance with an embodiment under various curvatures;

FIG. 8A includes an SEM image of a UMEA cleaved into small slices for an electrical connection between a UMEA and a ribbon cable in accordance with an embodiment;

FIG. 8B includes an SEM image of aligned ribbon cables to the backend of a UMEA and temporarily gluing detachable parts to a silicon wafer in accordance with an embodiment;

FIG. 8C includes an SEM image of aligned ribbon cables on the backend of a UMEA in accordance with an embodiment;

FIG. 8D includes an SEM image of ribbon cables electrically connecting beneath a UMEA in accordance with an embodiment;

FIG. 8E includes an SEM image of partially coated backend of a UMEA and a ribbon cable in adhesive epoxy before being released from a silicon wafer in accordance with an embodiment;

FIG. 8F includes an SEM image of a UMEA connected to a flexible ribbon cable in accordance with an embodiment;

FIG. 8G includes an SEM image of an assembled UMEA connected to a ribbon cable and mounted to a vacuum puck in accordance with an embodiment;

FIG. 8H includes an SEM image of electrode sites coated with SIROF for a ribbon cable in accordance with an embodiment;

FIG. 9A includes a representative cyclic voltammogram obtained from a 200 μm2 SIROF electrode from a UMEA connected to a flexible ribbon cable and inserted into a PBS agarose gel with sweep rate of 50 mV/s for a ribbon cable in accordance with an embodiment;

FIG. 9B includes a representative cyclic voltammogram obtained from a 200 μm2 SIROF electrode from a UMEA connected to a flexible ribbon cable and inserted into a PBS agarose gel with a sweep rate of 5000 mV/s for a ribbon cable in accordance with an embodiment;

FIG. 9C includes an average electrochemical impedance spectroscopy from 10 electrode channels with the bars representing SD for a ribbon cable in accordance with an embodiment;

FIG. 9D includes an optical image of an electrochemical setup including a ribbon cable connected to an omnetics cable and vacuum pick to insert the UMEA into gel for a ribbon cable in accordance with an embodiment;

FIG. 10A includes a diagram of ribbon cable implantation on the primary motor cortex (M1) of the rat in accordance with an embodiment;

FIG. 10B includes a representative picture of the 4-shank a-SiC UMEA upon insertion into the cortex of the rat after the dura mater was removed on the primary motor cortex (M1) of the rat in accordance with an embodiment;

FIG. 10C includes a representative continuous recording using two 4-pole Butterworth filters (300-3000 Hz) for a single unit for a ribbon cable on the primary motor cortex (M1) of the rat in accordance with an embodiment;

FIG. 10D includes two representative electrode sites with detected single units. Electrode site 1 shows two different units present, while electrode site 2 detected only one unit on the primary motor cortex (M1) of the rat in accordance with an embodiment;

FIG. 10E includes an interspike interval distribution for two of the detected units on the primary motor cortex (M1) of the rat in accordance with an embodiment; and

FIG. 10F includes a Spike trough-to-peak duration for both detected units for the identification of different neuron types on the primary motor cortex (M1) of the rat in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the ribbon cable arts.

Ribbon cables, also known as flat conductor cables, flexible flat cables, or multi-wire planar cables, are comprised of a set of insulated conducting wires arranged parallel in a plane. Thin film microfabricated ribbon cable technologies for implantable electronics have been proposed and developed in the past three decades. While ribbon cables provide interconnects that are flexible and bendable, they are not inherently stretchable. This work presents the geometrical design, fabrication and characterization of ultraflexible and stretchable polyimide ribbon cables with thin film metal traces and amorphous silicon carbide thin film interlayers. The ribbon cables are fabricated with high resolution (trace dimension of 2-10 μm) using photolithography-based microfabrication processes, which allows for custom geometrical layout designs. The fabricated ribbon cables demonstrated high flexural performance by bending in a radius of 50 μm with negligible change in impedance. In this work, a ribbon cable layout capable of 220% extension under small forces is introduced and tested for robust stretchability using 50,000 cycles of stretching about 45% of their initial length. The use of ultra-flexible and stretchable ribbon cables with implantable neural microelectrode arrays (MEA) is expected to case implantation procedures and improve MEA performance by reducing tethering forces. Here, we demonstrate the assembly of ribbon cables with ultra-thin chip MEA and evaluate MEA performance in an acute neural recording experiment in a rat cortex.

Aspects of the invention may include novel architecture designs and fabrication strategies for new flexible and stretchable generations of ribbon cables based on a-SiC/PI which can be used for a wide range of applications from wearable electronics to biosensors and neural interface interconnects; however, this research was conducted with the focus on ribbon cables suitable for intracortical MEAs.

### Results and Discussion

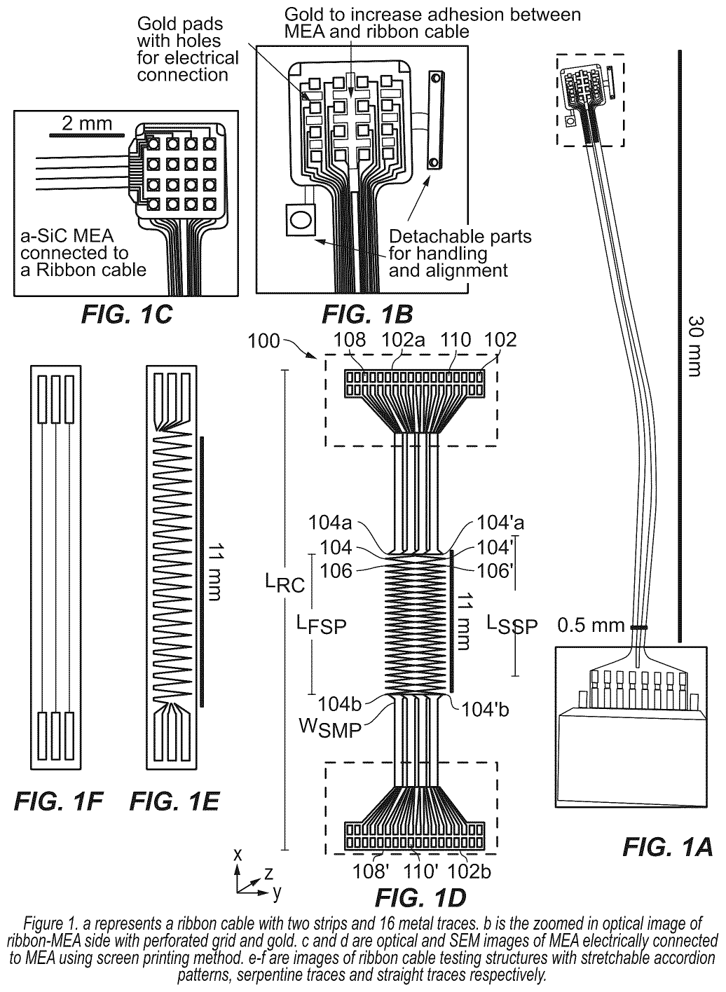

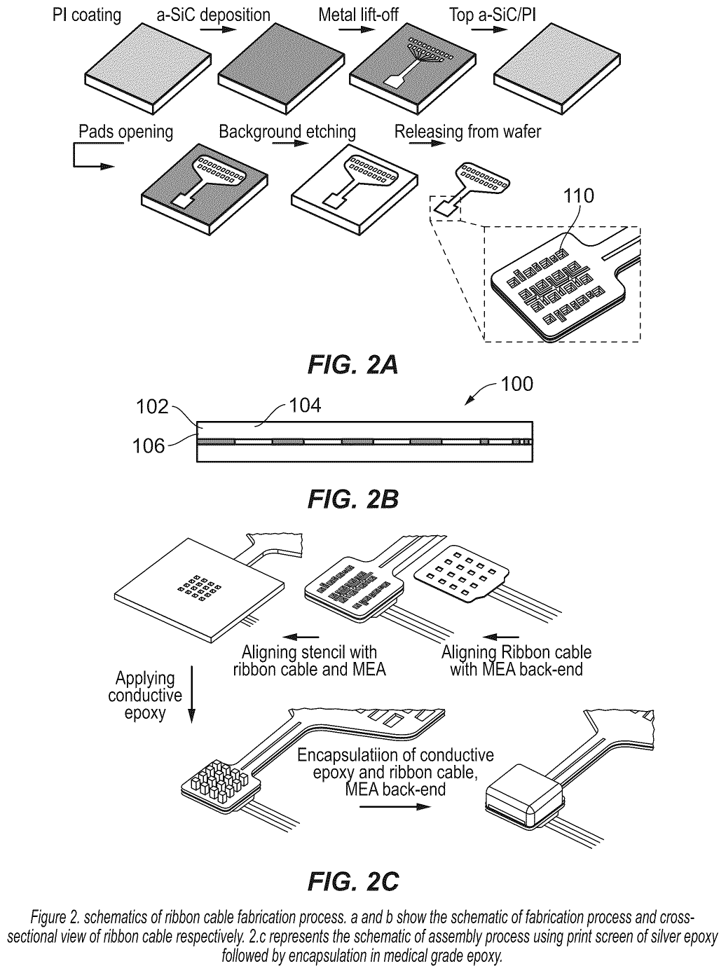

Various flexible and stretchable ribbon cable designs fabricated as part of this study are shown in FIG. 1. These geometries of the ribbon cables are designed to provide high flexibility, characterized by a low bending stiffness (FIG. 1A), and in some designs, a combination of flexibility and extensibility (FIG. 1B). We define extensibility as the reversible, non-damaging increase in longitudinal length that a ribbon cable can accommodate without fracture or increase in the electrical resistance of the metal traces connecting the distal and proximal bond pads on the cable. FIG. 1A represents a flexible ribbon cable with 16 metal traces that are divided into two longitudinal strips with eight traces on each strip. Splitting the cable into two strips allows increased rotational as well as bending capability. An omnetic backend at one side and one that matches an in-house made a-SiC penetrable MEA, i.e., ribbon cable-MEA side (FIG. 1B). Ribbon cable-MEA side includes perforated grid patterns that provide better attachment between the ribbon and MEA during the encapsulation process. In addition, some detachable features are added to this design, facilitating handling, aligning, and reducing the risk of mechanical damage during the assembly process. Ribbon cable testing structures are shown in FIGS. 1E-F in which FIG. 1E represents an accordion structure with embedded serpentine traces, suitable for tensile extension. FIG. 1F represents a ribbon cable with similar embedded serpentine traces without an accordion outline and FIG. 1E demonstrates ribbon cable structures with similar cross-sectional dimensions with straight-line traces. All structures were fabricated in the cleanroom facility at The University of Texas at Dallas. FIG. 2A provides an overview of the ribbon cable fabrication process with a cross-sectional view shown in FIG. 2B, followed by an assembly process in which ribbon cables were connected to microelectrode arrays (FIG. 2C). The process started by spin-coating a layer of PI (HD Microsystem PI 2611) with a thickness range of 5.5-6 μm on a silicon wafer, followed by a soft baking step on a 200° C. hotplate for 10 minutes and hard curing at 350° C. for 1.5 hours. After the PI layer was cured, a film of a-SiC with a thickness of 500 nm was deposited on the PI coated Si wafer using PE-CVD. Metal traces were then patterned using a photolithography process with a negative photoresist (nLOF 2020). In order to facilitate the lift-off process, a thin layer (˜500 nm) of non-photo-sensitive resist (MicroChem LOR 5A) was spin-coated under the photoresist. Ti/Au/Ti with thicknesses of 30/250/30 nm was then deposited using an electron beam metal evaporation system and was lifted off with the photoresist stripper solution and rinsed with deionized water (DIW). After a 10 minute dehydration bake, another layer of a-SiC with 500 nm was deposited. Next, 5.5-6 μm PI film was coated to complete sandwiching metal traces in a-SiC and PI layers. To open the pads on both ends of the interconnects, a layer of photosensitive resist (Megaposit SPR 220-7.0) was spin coated and patterned. Top PI and a-SiC were then etched in a reactive ion etching (RIE) chamber using O₂ plasma followed by a mixture of O₂ and SF₆ plasma. Finally, another lithography process was used to define the outline of the ribbon cables and the background PI was then etched in O₂ plasma. Samples were then released overnight by soaking in DIW.

### Extensibility

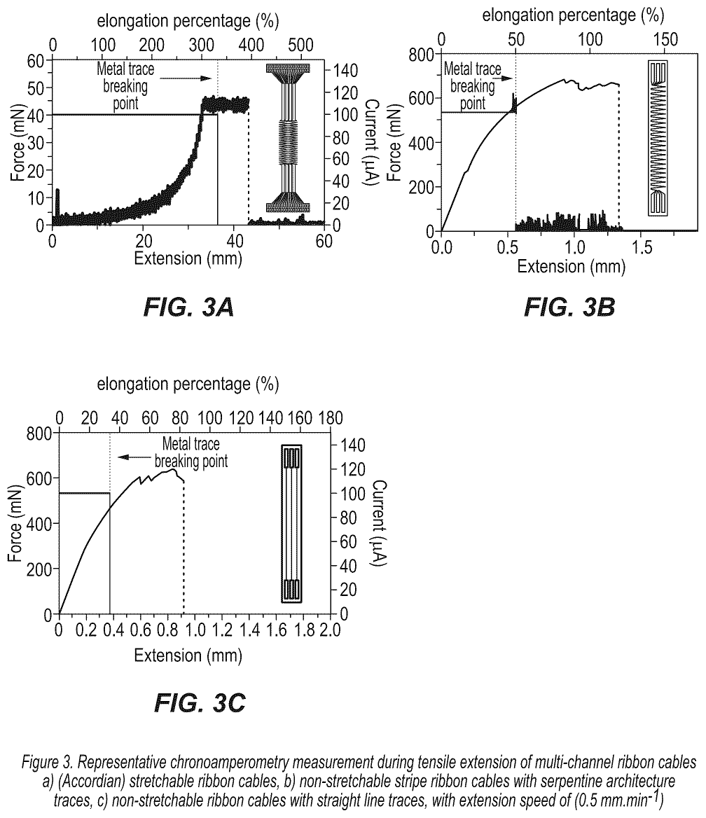

Ribbon cables can be adapted in designs and geometries to be compatible with their specific applications and tuned to match the backend circuitries using a similar fabrication process and assembly. As the neural interface application was the focus of this research, and in many cases, the ribbon cables have to tolerate extensive extensions similar to the dynamic environment in which they are implanted. We introduced a design of ribbon cables with an accordion structure (FIG. 1D) to provide extrinsically stretchability by providing a 3D-architectured ribbon from a planar structure that alleviates the strain and accommodates for a large extension without inducing large deformation in the entire structure specifically in the a-SiC layers and conductive traces. In order to illustrate the value of this structure in providing the stretchability, we built ribbon cable testing structures with three different designs: accordion (stretchable; FIG. 3A), striped with serpentine metal trace (non-stretchable; FIG. 3B) and striped ribbon cables with straight metal traces (FIG. 3C). We evaluated the extensibility of these designs by applying a continuous tensile extension force with an extension speed of 0.5 mm·min⁻¹, while simultaneously measuring the electrical resistance of metal traces under a monitored chronoamperometry system. These measurements were performed using a Gamry 600⁺ and Instron simultaneously (see experimental section). Ribbon cables with accordion configuration demonstrated excellent extensibility as their shape accommodated more strains by reforming to a 3D-shaped structure from a planar structure without inducing significant plastic deformation and therefore maintaining the electrical connections. Stretchable ribbons were extended approximately three times of initial lengths before breakage happened and maintained the electric conductivity to approximately 220% of total elongation. This value was significantly lower for stripe ribbon cables with serpentine (0.58 mm±SD) and straight traces (0.4 mm±SD). As motions in the stripe cables are confined in two dimensions, it is expected that the deformation of microstructures starts faster than accordion structures which provide multiaxial movements [31]. Although serpentine metal traces in stripe cables improved the extension tolerance compared to straight metal traces, the extension remains negligible (FIG. 3).

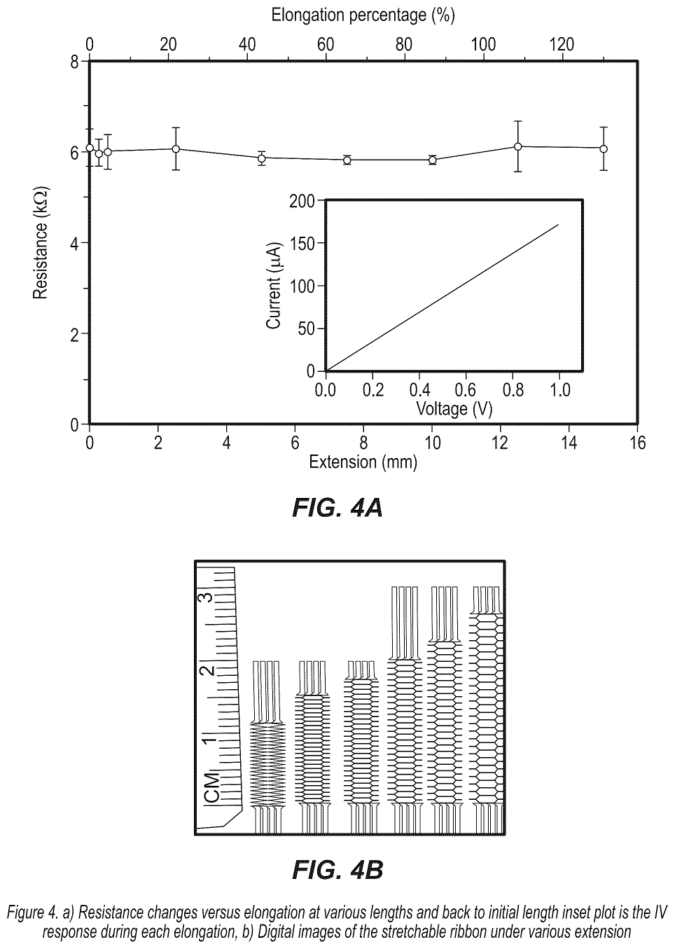

In addition, for accordion ribbon cable structures, electrical resistance for multiple channels (3-5) at various elongation percentages was measured and plotted in FIG. 4. As shown electrical resistance remains stable (5.84 kΩ) without any noticeable change during 135% elongation and back to the initial length. No hysteresis was observed when the ribbon was released back to its initial length from an elongation of 135%. Resistance of the ribbon (reciprocal of I-V curve slope) does not change, suggesting that the ribbon deformation and this length are within its clastic region.

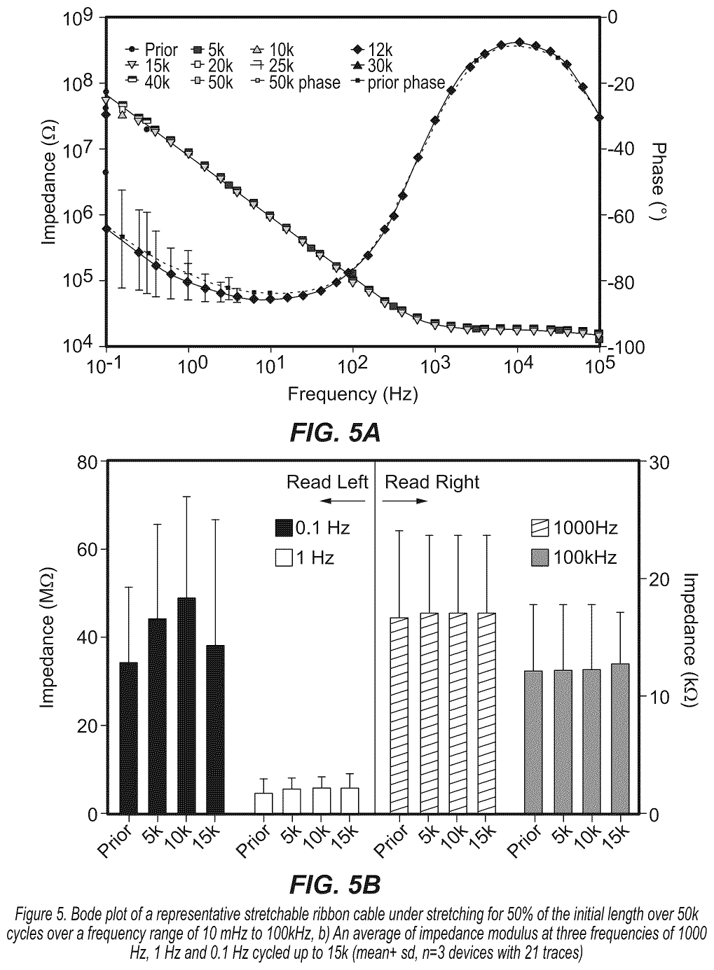

Furthermore, electrical/mechanical durance of stretchable ribbon cables was investigated for 45% extension up to 50,000 cycles, in which impedance from metal pads was measured in phosphate buffer saline (PBS) solution during extension (See the experimental setup). As shown in FIG. 5A, there was no change in impedance over the entire tested frequency range (10 mHz-100 kHz), however, some changes in a phase at a lower frequency were observed. FIG. 5B shows the impedance in three frequencies of 0.1 Hz, 1 Hz, and 1 kHz average of three ribbon cables (n=3).

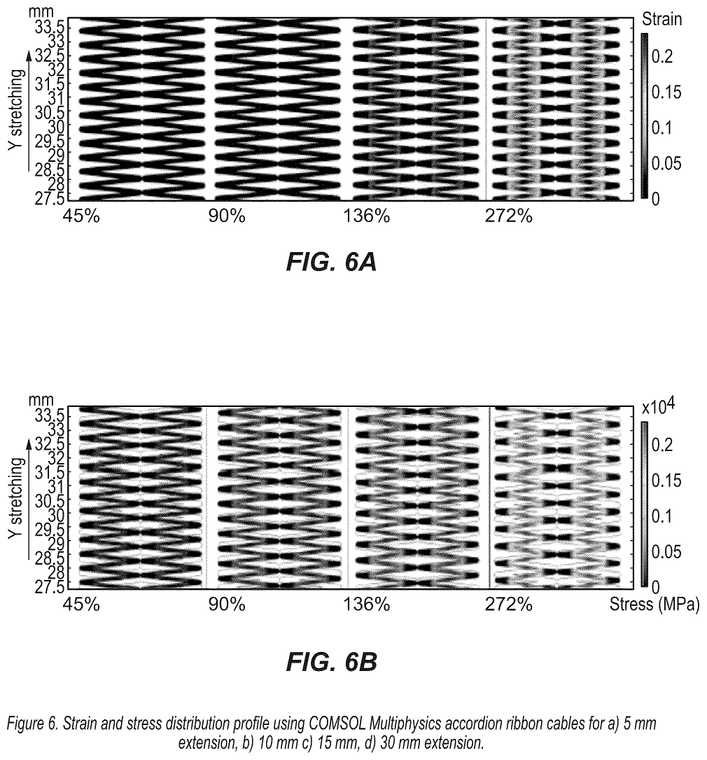

The finite element analysis using modeling COMSOL Multiphysics indicates the maximum principal strain of about 0.25% for an applied 272% strain (extension of 3 cm) focused on the corners of the accordion structure the stress is localized at a corner of the accordion and FIG. 6 shows of such stretchable ribbon cables.

### Flexibility Measurements

Flexural rigidity or bending stiffness (K) was defined as the force required to bend a fixed non-rigid structure by one unit of curvature (ref). For a rectangular structure it is collated to the second moment of inertia and Young's modulus (E): K=( 1/12×ab³)×E.

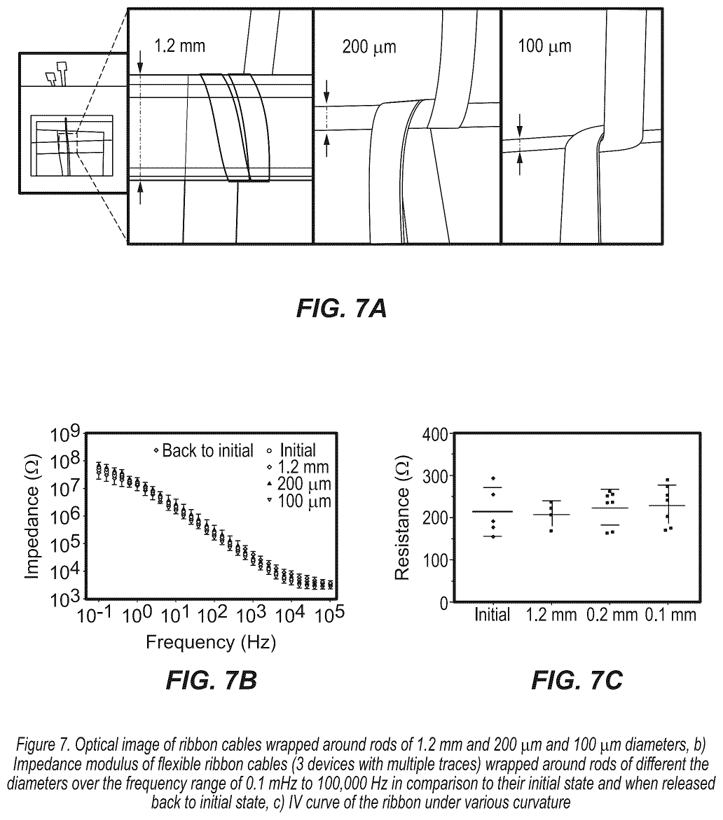

Reducing the dimensions in E results in lower K and more flexibility. However, lowering the EE may increase the risk of permanent deformation of the material. Therefore, an engineering design seems to be a viable approach to improve flexibility without compromising on the material properties. To improve bending stiffness, flexible ribbon cables were comprised of multiple stripes with merged ends instead of a single stripe which reduces the cross-section of total interconnects without compromising the total number of channel-count. Flexibility of these flexible interconnects was investigated by wrapping the ribbons around rods of various diameters; 1.2 mm, 200 μm and 100 μm (FIG. 7).

As seen in FIG. 7, the impedance magnitude and electrical resistance of these ribbon cables did not show a noticeable change under these fine radii of curvatures suggesting excellent bendability.

### Demonstration of Neural Interface Application

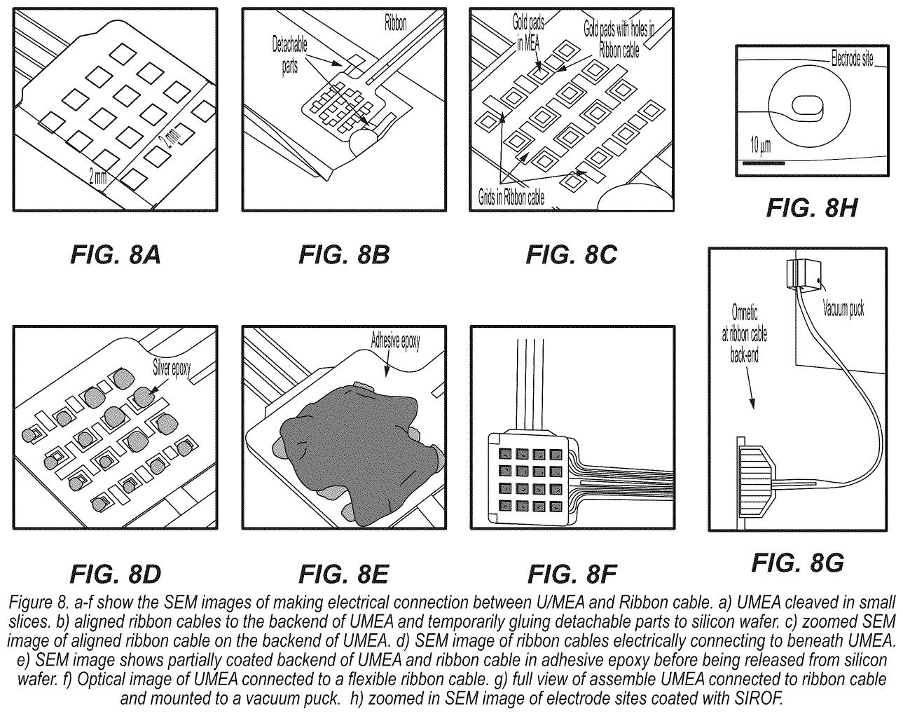

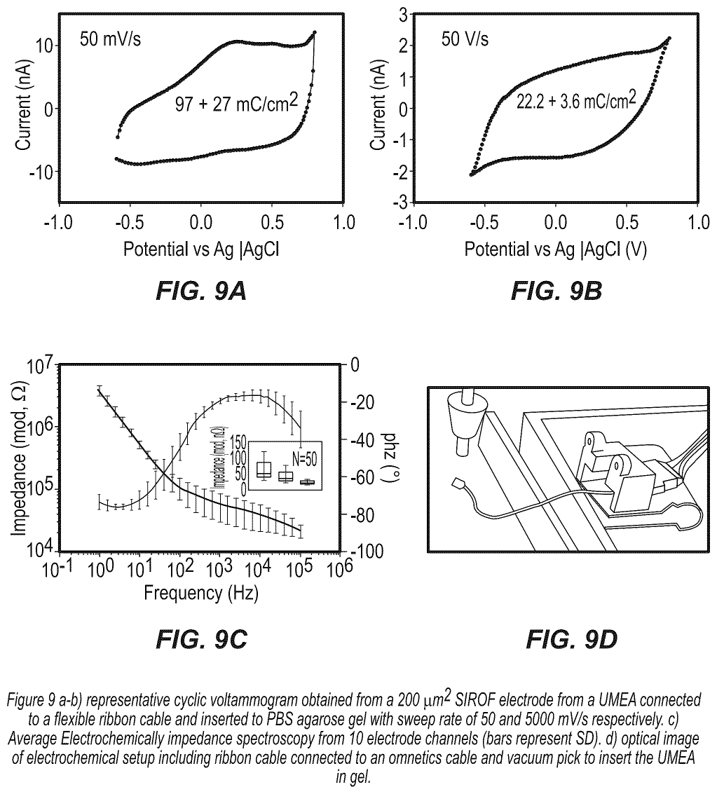

Finally, to demonstrate the compatibility of ribbon cable interconnects with MEAs, which is critical for deploying ribbon cables for neural interface applications [32, 33], the ribbon cables were connected to the in-house made a-SiC-based 4-shank ultramicroelectrode arrays (UMEAs) with a cross-sectional area of 120 μm2 using conductive epoxy and a contact printing method. Later devices were encapsulated in a medical-grade epoxy shown in FIG. 8. The backend of ribbon cable was mounted to a 3D printed custom design rodent head-mount pedestal (FIG. 8D) and the backend of UMEA was fixed into a vacuum puck (FIG. 8G). The a-SiC possesses up to 16 sputtered iridium oxide film (SIROF) electrode sites, forming a low-impedance film suitable for neural recording and stimulations [34]. To assess the functionality of assembled structures, the electrochemical properties from electrode sites were measured in agarose-mixed PBS gel and demonstrated with cyclic voltammetry (CV) and impedance spectroscopy (EIS) in (FIG. 9). As shown, the properties of the final assembled devices are consistent with previous SIROF findings reported by our group [35, 36]. The overall impedance of the system was not affected, which confirms the electrical connection between the ribbon cables and electrode sites. Cathodic charge storage capacity (CSCc) was measured and found to be approximately between 97 mC·cm-2 and 22.2 mC·cm-2 for the potential sweeping rate of 50 mV·s-1 and 5 V·s-1, respectively (FIG. 9). The impedance of electrodes was approximately 50 kΩ at the frequency of 1 kHz—an impedance value for 200-μm2 SIROF electrode consistent. These results suggest the amenability of the PI-a-SiC interconnects for neural interface applications.

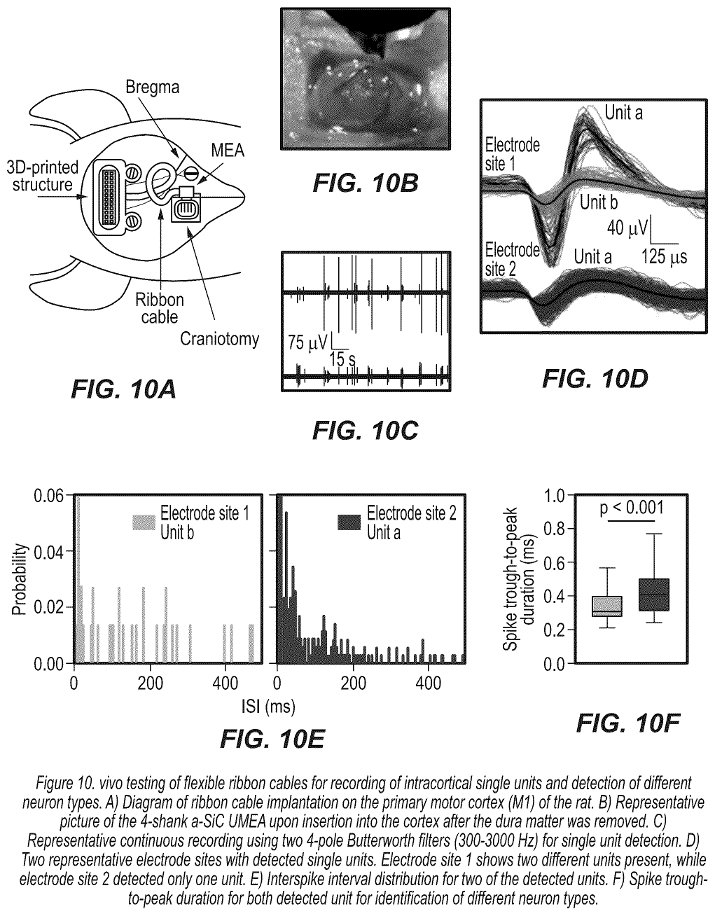

A flexible ribbon cable connected to an in-house made 4-shank a-SiC UMEA with 16 electrode sites was prepared for implantation into the Sprague-Dawley motor cortex. The omnetics connector was housed in a custom 3D-printed structure and anchored to the skull using two stainless steel screws as shown in FIG. 10A. A 3×2 mm craniotomy was done over the primary motor cortex (M1) and the dura was removed to allow UMEA insertion to a depth of 1.8 mm from the surface (FIG. 10B). Intracortical neural single-unit activity was recorded under anesthesia immediately after insertion for 10 minutes (FIG. 10C) to assess electrode functionality. Single-unit activity was present with multiple channels showing more than one single unit (FIG. 10D). The signal Vpp was found to be 75.6±68.0 μV (range between 33.2 to 154.0 μV), with a signal-to-noise level of greater than 1. In addition, the interspike interval distribution of the single units identified and spike trough-to-peak duration (FIGS. 10E-F) suggest the presence of two different neuron types: putative interneurons (green) and putative pyramidal neurons (red). The interspike interval of the putative interneurons was characterized by a broad and short histogram with a narrow spike width; the putative pyramidal neurons interspike interval was characterized by a right skew distribution and a wider spike width, consistent with previous neuron type descriptions [37]. These findings demonstrate the feasibility of the ribbon cables to selectively record from individual neurons, with a sufficient signal quality to identify different neuron types.

Referring to FIG. 1D, a ribbon cable 100 is shown according to a number of embodiments. In a number of embodiments, the ribbon cable 100 may be implantable upon a biological substrate, as described herein. The ribbon cable 100 may include a ribbon cable body 102 in a longitudinal (x), lateral (y) and transversal (z) dimensional axis system including a length, L_{RC}, between a first axial end 102a and a second axial end 102b down a central longitudinal (x) axis. The ribbon cable body 102 may include at least one stretchable electrically conductive material portion 104 along at least a portion of the length, L_{RC}. The at least one stretchable electrically conductive material portion 104 may have a width, W_{SMP}, in the lateral (y) direction of between 1 and 15 μm. The at least one stretchable electrically conductive material portion 104 can be configured in conformance with the overall interconnect geometry of a desired application. In a number of embodiments, the stretchable electrically conductive material portion 104 may include an electrically conductive material. As shown in FIG. 1D, the ribbon cable body 102 may include a plurality of stretchable electrically conductive material portions 104, 104′ along at least a portion of the length, L_{RC}. As shown in FIG. 1D, the ribbon cable body 102 may include a plurality of stretchable electrically conductive material portions 104, 104′ may include at least 4 stretchable electrically conductive material portions, such as at least 8 stretchable electrically conductive material portions, or such as at least 16 stretchable electrically conductive material portions along at least a portion of the length, L_{RC}. As shown in FIG. 1D, the at least one stretchable electrically conductive material portion 104, 104′ may be oriented in a substantially flat accordion pattern in a longitudinal (x)/lateral (y) plane down the central axis. In a number of embodiments, the stretchable electrically conductive material portion 104, 104′ may be capable of re-orienting out of the longitudinal (x)/lateral (y) plane into the traversal (z) dimension when stretched in the longitudinal (x)/lateral (y) plane. In a number of embodiments, as described above regarding FIGS. 3A-5B, the ribbon cable 100 may be stretchable to at least 150% of its length down the central longitudinal (x) axis, such as at least 170%, such as at least 190%, such as at least 200%, such as at least 210%, or such as at least 220% of its length, L_{RC}, down the central longitudinal (x) axis while maintaining an electrical connection (e.g. resistance, impedance) along its length, L_{RC}, when stretched. In a number of embodiments, as described above regarding FIGS. 7A-7C, the ribbon cable 100 may be bendable about a radius of less than 1.2 mm while maintaining an electrical connection (e.g., resistance, impedance) along its length, L_{RC}, when bent. Additional testing will be done on the mechanism of bending and stretching the ribbon cable 100 according to embodiments herein while maintaining an electrical connection.

As shown in FIG. 1D, the accordion pattern of the at least one stretchable electrically conductive material portions 104, 104′ of the ribbon cable body 102 may each have a zig-zag pattern oriented substantially parallel down the central longitudinal (x) axis. The zig-zag pattern may move laterally in a switchback orientation down the central longitudinal (x) axis as shown. In a number of embodiments, the accordion pattern of the at least one stretchable electrically conductive material portions 104, 104′ of the ribbon cable body 102 may include a plurality of stretchable electrically conductive material portions 104, 104′ each having a zig-zag pattern oriented substantially parallel down the central longitudinal (x) axis. This accordion orientation may form a bellows-like arrangement as shown in FIG. 1D.

The at least one stretchable electrically conductive material portion 104, 104′ can include one or more layers of materials. Electrically conductive materials useful for the at least one stretchable electrically conductive material portions 104, 104′ include metallic conducting materials such as copper, silver, gold, aluminum and the like. Alternatively, the at least one stretchable electrically conductive material portion 104, 104′ may include organic conducting materials such as polyaniline. Suitable stretchable electrically conductive material portions 104, 104′ may include a semiconductor, either inorganic like silicon or indium tin oxide, or organic-like pentacene or polythiophene. Alternatively, stretchable electrically conductive material portions 104, 104′ can be alloys instead of stoichiometric elements or compounds.

Still referring to FIG. 1D, in an embodiment, the at least one stretchable electrically conductive material portions 104, 104′ of the ribbon cable body 102 may be formed on or embedded within a substrate 106. In a number of embodiments, at least two of the plurality of stretchable electrically conductive material portions 104, 104′ may each be formed on or embedded within a first substrate portion 106 and a second substrate portion 106′ respectively. In a number of embodiments, the first substrate portion 104 may have a length, L_{FSP}, between a first axial end 104a and a second axial end 104b and the second substrate portion 104′ may have a length, L_{SSP}, between a first axial end 104′a and a second axial end 104′b, wherein the first substrate portion 106 and the second substrate portion 106′ may contact one another along a discrete portion of their respective lengths. Alternatively, as shown in FIGS. 1F and 1E, the ribbon cable 102 may include a single substrate portion 106 with at least one stretchable electrically conductive material portion 104, 104′ of the ribbon cable body 102 formed thereon or embedded within. The at least one stretchable electrically conductive material portion 104, 104′ can be formed on substrate 106 by electron beam evaporation, thermal evaporation, sputter deposition, chemical vapor deposition (CVD), electroplating, molecular beam epitaxy (MBE) or any other conventional means. The at least one stretchable electrically conductive material portions 104, 104′ can be very thin of a mono or few atomic layers in the (z) dimension.

Still referring to FIG. 1D and now referring to FIGS. 2A-2C, the ribbon cable body 102 of the ribbon cable 100 may further include at least one pad 108 on at least one axial end 102a, 102b of the ribbon cable body 102 down the central longitudinal (x) axis. In a number of embodiments, the ribbon cable body 102 of the ribbon cable 100 may further include a plurality of pads 108, 108′, one on each axial end 102a, 102b of the ribbon cable body 102 down the central longitudinal (x) axis. The at least one pad 108, 108′ may include a plurality of trace ends 110, 110′ for electrically connecting the ribbon cable 100 to a neighboring component. In a number of embodiments, at least one of the plurality of trace ends 110, 110′ may be electrically connected to at least one stretchable electrically conductive material portion 104, 104′.

In one aspect of the present invention, the substrate 106 can be an organic or inorganic material that can be stretched reversibly or stretched non-reversibly. A material that can be stretched non-reversibly can be deformed only once. Materials that can be stretched reversibly in order to be stretched and relaxed repeatedly are elastomeric, and rubber-like. Elastomeric materials include carbon-based or silicon-based polymeric rubbers. Suitable elastomeric materials are silicone rubber, such as polydimethyl siloxane (PDMS) and acrylic rubber. Materials that can be deformed once include plastic materials. Suitable plastic materials include polyethylene terephthalate. Alternatively, substrate 106 can be formed of polymeric materials which are partly clastic and partly plastic. A suitable polymeric material is polyimide. The characteristic of the elastomeric or plastic material can depend strongly on temperature. The geometry of substrate 106 can be determined for a desired use. For example, substrate 106 can have a thickness of less than about 1 μm to about 1 cm and an area in the range of about 1 μm² to about 1 m² or more.

Referring now to FIGS. 2A-2C, a method of fabrication for the ribbon cable is shown as described above. As shown best in FIG. 2B, the ribbon cable body 102 may include a stretchable electrically conductive material portion 104 which may include an electrically conductive material. In a number of embodiments, the stretchable electrically conductive material portion 104 may include an electrically conductive material selected from the group including at least one of copper, silver, gold and aluminum. Further, the ribbon cable body 102 may include a substrate 106 into which the stretchable electrically conductive material portion 104 may be formed thereon or embedded within. The substrate 106 may include a polymer layer. In a number of embodiments, the substrate 106 may include a polyimide layer. In a number of embodiments, the substrate 106 may include a ceramic layer. In a number of embodiments, the substrate 106 may include a silicon carbide layer. In a number of embodiments, the substrate 106 may include a ceramic layer overlying a polymer layer. In a number of embodiments, the substrate 106 may include a silicon carbide layer overlying a polyimide layer. As shown in FIG. 2B, the ribbon cable body 102 may include a polymer layer with a ceramic layer and the stretchable electrically conductive material portion 104 formed thereon. A second polymer layer may then be formed over the ceramic layer and the stretchable electrically conductive material portion 104.

### Conclusion

In order to have a long-life implantable bioelectronic system and neural interfaces, these devices should tolerate harsh mechanical conditions. We showed how tuning design and modifying geometries can be a practical approach to improve mechanical durability and extensibility of electronic interconnects. Non-stretchable ribbon cables demonstrate excellent flexibility under various bending radii (0.6 mm to 50 μm) but a limited range of extensibility. Amongst the different ribbon cable designs, the non-stretchable with metal traces showed the lowest extensibility compared to the non-stretchable with serpentine stripe metal tracings. Accordion design for ribbons was found to be a viable design with a wide range of extension (up to 220%) without breakage in electrical connections by changing 2D fabricated structures to 3D devices and providing an extrinsic stretchability for intrinsically inextensible structures.

### Experimental Section

One end of interconnects was designed to be connected to a commercial 16-32 channel NPD pin connector (known as Omnetics connector) while the other end was designed to match the backend of a-SiC MEAs. This design also matches other commercially available 4×4 BlackRock probes. In this design metal pads were made with holes in the middle as well as some perforated slits (referred to as grids in the manuscript) in the outline structure, (FIG. 8C) to accommodate for ball bonding or conductive epoxy screen printing process and to increase adhesion at ribbon-MEA interface respectively. Omnetics connectors were connected to ribbon cables through conductive silver epoxy while the other end was aligned onto the MEA (FIG. 2C and FIG. 8B) and later the screen-printing method was used to electrically connect ribbon cables to MEAs. In this method, a custom designed transparent stencil was used to apply a thin layer of silver epoxy on the exposed gold pads, with holes in the center, bonding the metal traces of ribbon cables to the underneath metal traces in MEAs. The assembled structure was then cured in an oven at 87° C. for 3 hours. Lastly, the pads site was fully encapsulated in Loctite medical-grade adhesive epoxy.

### Mechanical Cycling

Long term mechanical characterization of the stretchable ribbons was carried out using a customized setup including an Ardunio microcontroller, an L12-P linear actuator, a 3D-printed structure to hold the actuator and vacuum syringe aligned. A stretchable ribbon was completely submerged in a PBS solution held between a fixed vacuum pump and a moving probe of the actuator. Ardunio was connected to the LAC board of the actuator to control the speed and motion range of the actuator probe and thus stretching the ribbon in a repeatable fashion. Electrochemical impedance spectroscopy was used to measure the change in impedance after every extension cycle. All ribbons were stretched up to 50% of the initial length while being soaked in PBS at room temperature.

### Mechanical Bending

Ribbon cables were wrapped around glass or rods with specified diameters while being held in a customized 3D-printed structure. For electrochemical measurements, gold pads and ribbon parts were submerged in PBS while the other end was connected to a commercial Omnetic connector and held outside of the solution. For electrical measurement, the ribbons were tested in air at room temperature while being wrapped around the rods. All gold pads on each side of the ribbons were shorted with silver paste epoxy and aluminum foil, connected to Gamry 600+ with nano alligator clips.

### Electrochemical Measurement of Ribbon Cables

Electrochemical characterization of the ribbons was performed using an electrochemical station (Gamry, 600+) in a PBS solution using a three-electrode configuration with platinum wire as the counter electrode, gold pads in the ribbon cables as working electrodes and Ag|AgCl as the reference electrode, in which the impedance of gold metal pads was obtained while sinusoidal potential wave of 10 mV versus open circuit potential was excited between a frequency of 0.1 Hz to 100 KHz.

### Electrochemical Measurement on the MEA Connected to the Ribbon Cables

Impedance spectroscopy from the SIROF electrodes in PBS agarose gel was obtained using the same setup described in the previous section. In addition, the cyclic voltammetry was performed using a three-electrode configuration to obtain the charge storage capacity of SIROF electrodes in vitro, in which the potential with respect to Ag|AgCl reference electrode was swept cyclically with the rates of 50 mV/s and 50 V/s, within the water electrolysis window, between-0.6 V and +0.8 V. Cathodal charge storage capacities were then calculated and averaged from time integral of cathodic current for both sweep rates as described previously by Cogan [36].

### Electrical Characterization of Ribbon Cables

Linear sweep voltammetry (LSV) was performed using a two-electrode configuration setup, in which a working electrode was connected to one side of a metal trace in the ribbon cable while counter and reference cables were both connected to the other side of the trace. Voltage was swept with 100 mV/s over a voltage of 0-1 V. Resistance was calculated from the slope of the LSV curve. Chronopotentiometry was also conducted with a two-electrode configuration setup, in which a constant current of 100 μA was delivered between two sides of a metal trace and voltage was measured while ribbons were mechanically extended. Metal trace breakage resulted in an abrupt drop in current, while the voltage reached the compliance limit of the potentiostat instrument.

### Animal and Surgical Procedures

All animals and surgical procedures were approved by the University of Texas at Dallas Institutional Animal Care and Use Committee (IACUC #18-13) as previously described [38]. One female Sprague-Dawley rat (340 g) was anesthetized using inhaled isoflurane (2-2.5%) combined with oxygen (500 mL/min). The scalp was shaved and the animal was placed in the stereotaxic frame followed by a subcutaneous injection of 0.5% lidocaine (0.16 mL) at the site of the incision. The anesthesia level was confirmed by the absence of a pinch reflex. A 3-cm anterior-posterior incision was made on the midline of the scalp and the skin and muscles were retracted to expose the skull. The omnetics connector was housed in a custom 3D-printed structure designed to hold two screws to anchor to the skull. Reference and ground wires were tied around a third screw on the skull for recording. A 3×2 mm craniotomy anterior to bregma was made on the right side of the skull using a surgical drill. A 30G needle was used to create a dural slit and then microscissors were used to extend the durotomy along the entire craniotomy area. The ribbon cable was held using a vacuum pump and inserted at 100 μm/s using a NeuralGlider Cortical Implant Inserter (Actuated Medical, Inc., Bellefonte, PA, USA). The implant was secured in place using Kwik-Cast silicone sealant (World Precision Instruments, Sarasota, FL, USA). The animal was euthanized with a sodium pentobarbital overdose at the end of the experiment.

### In Vivo Electrophysiological Recordings

We performed a 10-minute recording inside a grounded Faraday cage immediately after electrode implantation. Raw data was collected at 30 kHz using a Cereplex Direct acquisition system (Blackrock Neurotech, Salt Lake City, UT, USA) and a 16-channel headstage and processed offline using Offline Sorter (Plexon, Inc., Dallas, TX, USA). Two 4-pole Butterworth filters were applied for single unit analysis: 1) high-pass filter with a cut-off frequency of 300 Hz, and 2) low-pass filter with a cut-off frequency of 3 kHz. The signals were then further processed using a virtual common median reference to improve the detection of single units [39]. Single units were detected using a thresholding method set at −4*SD. Then, the Vpp was calculated as the amplitude between the minimum and maximum peaks of the recorded single units. The SNR was calculated as the squared standard deviation of the signal divided by the squared standard deviation of the noise in each channel. After single unit detection, we calculated the interspike interval distribution of two detected units using NeuroExplorer (Nex technologies, Colorado Springs, CO, USA) and the spike trough-to-peak duration as the time between the trough and peak of the waveform (spike width) using Matlab R2021a. The differences in the trough-to-peak duration between the putative neuron types were calculated using a non-parametric Mann-Whitney test in GraphPad Prism 9.3.1 for non-normal distribution.

### REFERENCES

[1] Lebedev M A and Nicolelis M A L 2006 Brain-machine interfaces: past, present and future Trends Neurosci. 29 536-46
[2] Nicolelis M A L 2003 Brain-machine interfaces to restore motor function and probe neural circuits Nat. Rev. Neurosci. 4
[3] Wang W, Degenhart A D, Collinger J L, Vinjamuri R, Sudre G P, Adelson P D, Holder D L, Leuthardt E C, Moran D W, Boninger M L, Schwartz A B, Crammond D J, Tyler-Kabara E C and Weber D J 2009 Human motor cortical activity recorded with micro-ECoG electrodes during individual finger movements Proc. 31st Annu. Int. Conf. IEEE Eng. Med. Biol. Soc. Eng. Futur. Biomed. EMBC 2009 586-9
[4] Kozai T D Y, Jaquins-Gerstl A S, Vazquez A L, Michael A C and Cui X T 2015 Brain tissue responses to neural implants impact signal sensitivity and intervention strategies ACS Chem. Neurosci. 6 48-67
[5] Barrese J C, Rao N, Paroo K, Triebwasser C, Vargas-Irwin C, Franquemont L and Donoghue J P 2013 Failure mode analysis of silicon-based intracortical microelectrode arrays in non-human primates J. Neural Eng. 10 066014
[6] Wellman S M, Eles J R, Ludwig K A, Seymour J P, Michelson N J, McFadden W E, Vazquez A L and Kozai T D Y 2018 A Materials Roadmap to Functional Neural Interface Design Adv. Funct. Mater. 28 1-38
[7] Subbaroyan J, Martin D C and Kipke D R 2005 A finite-element model of the mechanical effects of implantable microelectrodes in the cerebral cortex J. Neural Eng. 2 103-13
[8] Joo H, Jung D, Sunwoo S H, Koo J H and Kim D H 2020 Material Design and Fabrication Strategies for Stretchable Metallic Nanocomposites Small 16 1-19
[9] Arrabito G, Ferrara V, Bonasera A and Pignataro B 2020 Artificial Biosystems by Printing Biology Small 16 1-30
[10] Lv Z, Tang Y, Zhu Z, Wei J, Li W, Xia H, Jiang Y, Liu Z, Luo Y, Ge X, Zhang Y, Wang R, Zhang W, Loh X J and Chen X 2018 Honeycomb-Lantern-Inspired 3D Stretchable Supercapacitors with Enhanced Specific Areal Capacitance Adv. Mater. 30
[11] Dong R, Wang L, Hang C, Chen Z, Liu X, Zhong L, Qi J, Huang Y, Liu S, Wang L, Lu Y and Jiang X 2021 Printed Stretchable Liquid Metal Electrode Arrays for In Vivo Neural Recording Small 17 1-8
[12] Jimin Maeng, Rashed T. Rihani, Mahjabeen Javed, Jai Singh Rajput, Hyun Kim, Ian G. Bouton, Tyler A. Criss, Joseph J. Pancrazio, Bryan J. Black T H W 2020 Liquid crystal elastomers as substrates for 3D, robust, implantable electronics J. Mater. Chem. B 8 6286-95
[13] Kim R H, Kim D H, Xiao J, Kim B H, Park S Il, Panilaitis B, Ghaffari R, Yao J, Li M, Liu Z, Malyarchuk V, Kim D G, Le A P, Nuzzo R G, Kaplan D L, Omenetto F G, Huang Y, Kang Z and Rogers J A 2010 Waterproof AlInGaP optoelectronics on stretchable substrates with applications in biomedicine and robotics Nat. Mater. 9 929-37
[14] Kisban S, Herwik S, Seidl K, Rubchn B, Jezzini A, Umiltà M A, Fogassi L, Stieglitz T, Paul O and Ruther P 2007 Microprobe array with low impedance electrodes and highly flexible polyimide cables for acute neural recording Annu. Int. Conf. IEEE Eng. Med. Biol. -Proc. 3 175-8
[15] Hsu J, Rieth L, Normann R A, Tathireddy P and Solzbacher F 2009 Encapsulation of an Integrated Neural Interface Device With Parylene C IEEE Trans. Biomed. Eng. 56 23-9
[16] Hassler C, Von Metzen R P, Ruther P and Stieglitz T 2010 Characterization of parylene C as an encapsulation material for implanted neural prostheses J. Biomed. Mater. Res.—Part B Appl. Biomater. 93 266-74
[17] Winslow B D, Christensen M B, Yang W K, Solzbacher F and Tresco P A 2010 A comparison of the tissue response to chronically implanted Parylene-C-coated and uncoated planar silicon microelectrode arrays in rat cortex Biomaterials 31 9163-72
[18] Stieglitz T, Beutel H, Schuettler M and Meyer J U 2000 Micromachined, polyimide-based devices for flexible neural interfaces Biomed. Microdevices 2 283-94
[19] Xiang Z, Yen S C, Xue N, Sun T, Tsang W M, Zhang S, Liao L De, Thakor N V. and Lee C 2014 Ultra-thin flexible polyimide neural probe embedded in a dissolvable maltose-coated microneedle J. Micromechanics Microengineering 24
[20] Szymanski L J, Kellis S, Liu C Y, Jones K T, Andersen R A, Commins D, Lee B, McCreery D B and Miller C A 2021 Neuropathological effects of chronically implanted, intracortical microelectrodes in a tetraplegic patient J. Neural Eng. 18 0460b9
[21] Ceyssens F and Puers R 2015 Insulation lifetime improvement of polyimide thin film neural implants J. Neural Eng. 12
[22] Hassler C, Boretius T and Stieglitz T 2011 Polymers for neural implants J. Polym. Sci. Part B Polym. Phys. 49 18-33
[23] Li W, Rodger D, Menon P and Tai Y-C 2019 Corrosion Behavior of Parylene-Metal-Parylene Thin Films in Saline ECS Trans. 11 1-6
[24] Murray S, Hillman C and Pecht M 2004 Environmental aging and deadhesion of polyimide dielectric films J. Electron. Packag. Trans. ASME 126 390-7
[25] Cheung K C, Renaud P, Tanila H and Djupsund K 2007 Flexible polyimide microelectrode array for in vivo recordings and current source density analysis Biosens. Bioelectron. 22 1783-90
[26] Kang S K, Hwang S W, Cheng H, Yu S, Kim B H, Kim J H, Huang Y and Rogers J A 2014 Dissolution behaviors and applications of silicon oxides and nitrides in transient electronics Adv. Funct. Mater. 24 4427-34
[27] Cogan S F, Edell D J, Guzelian A a, Ping Liu Y and Edell R 2003 Plasmaenhanced chemical vapor deposited silicon carbide as an implantable dielectric coating. J. Biomed. Mater. Res. A 67 856-67
[28] Harder C, Rzany A and Schaldach M 1999 Coating of Vascular Stents with Antithrombogenic Amorphous Silicon Carbide Prog. Biomed. Res. 4 71-7
[29] Wang P, Hu M, Wang H, Chen Z, Feng Y, Wang J, Ling W and Huang Y 2020 The Evolution of Flexible Electronics: From Nature, Beyond Nature, and To Nature Adv. Sci. 7 1-29
[30] Kim D H, Liu Z, Kim Y S, Wu J, Song J, Kim H S, Huang Y, Hwang K C, Zhang Y and Rogers J A 2009 Optimized structural designs for stretchable silicon integrated circuits Small 5 2841-7
[31] Lee H C, Hsieh E Y, Yong K and Nam S W 2020 Multiaxially-stretchable kirigami-patterned mesh design for graphene sensor devices Nano Res. 13 1406-12
[32] Oh K, Byun D and Kim S 2017 Polymer-based interconnection cables to integrate with flexible penetrating microelectrode arrays Biomed. Microdevices 19
[33] Stieglitz T and Meyer J-U 2007 Biomedical Microdevices for Neural Implants BioMEMS 71-137
[34] Maeng J, Chakraborty B, Geramifard N, Kang T, Rihani R T, Joshi-Imre A and Cogan S F 2020 High-charge-capacity sputtered iridium oxide neural stimulation electrodes deposited using water vapor as a reactive plasma constituent J. Biomed. Mater. Res.—Part B Appl. Biomater. 108 880-91
[35] Cogan S F, Ehrlich J, Plante T D, Smirnov A, Shire D B, Gingerich M and Rizzo J F 2009 Sputtered iridium oxide films for neural stimulation electrodes J. Biomed. Mater. Res.—Part B Appl. Biomater. 89 353-61
[36] Cogan S F 2008 Neural Stimulation and Recording Electrodes
[37] Li M, Wang X, Yao X, Wang X, Chen F, Zhang X, Sun S, He F, Jia Q, Guo M, Chen D, Sun Y, Li Y, He Q, Zhu Z and Wang M 2021 Roles of Motor Cortex Neuron Classes in Reach-Related Modulation for Hemiparkinsonian Rats Front. Neurosci. 15 1-23
[38] Usoro J O, Dogra K, Abbott J R, Radhakrishna R, Cogan S F, Pancrazio J J and Patnaik S S 2021 Influence of implantation depth on the performance of intracortical probe recording sites Micromachines 12
[39] Rolston J D, Gross R E and Potter S M 2009 Common median referencing for improved action potential detection with multielectrode arrays Proc. 31st Annu. Int. Conf. IEEE Eng. Med. Biol. Soc. Eng. Futur. Biomed. EMBC 2009 1604-7

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A ribbon cable comprising: a ribbon cable body in a longitudinal (x), lateral (y) and transversal (z) dimensional axis system comprising a length down a central longitudinal (x) axis, wherein the ribbon cable body comprises at least one stretchable electrically conductive material portion along at least a portion of the length, wherein the stretchable electrically conductive material portion is oriented in a substantially flat accordion pattern in a longitudinal (x)/lateral (y) plane down the central axis, wherein the stretchable electrically conductive material portion is capable of re-orienting out of the longitudinal (x)/lateral (y) plane into the traversal (z) dimension when stretched in the longitudinal (x)/lateral (y) plane.

Embodiment 2: A method comprising: providing a ribbon cable comprising a ribbon cable body in a longitudinal (x), lateral (y) and transversal (z) dimensional axis system comprising a length down a central longitudinal (x) axis, wherein the ribbon cable body comprises at least one stretchable electrically conductive material portion along at least a portion of the length, wherein the stretchable electrically conductive material portion is oriented in a substantially flat accordion pattern in an longitudinal (x)/lateral (y) plane down the central axis; and stretching the stretchable electrically conductive material portion in the longitudinal (x)/lateral (y) plane to re-orient the stretchable electrically conductive material portion out of longitudinal (x)/lateral (y) plane into the traversal (z) dimension.

Embodiment 3: The ribbon cable of embodiment 1, wherein the stretchable electrically conductive material portion comprises a material selected from the group comprising at least one of copper, silver, gold and aluminum.

Embodiment 4: The ribbon cable of embodiment 1, wherein the accordion pattern comprises a plurality of stretchable electrically conductive material portions each having a zig-zag pattern oriented substantially parallel down the central longitudinal (x) axis.

Embodiment 5: The ribbon cable of embodiment 1, wherein the ribbon cable body further comprises a substrate, wherein the stretchable electrically conductive material portion is formed on or embedded within the substrate along at least a portion of a length of the stretchable electrically conductive material portion.

Embodiment 6: The ribbon cable of embodiment 5, wherein at least two of the plurality of stretchable electrically conductive material portions having a zig-zag pattern are each formed on or embedded within a first substrate portion and a second substrate portion respectively, wherein the first substrate portion and the second substrate portion each have a respective length, wherein the first substrate portion and the second substrate portion contact one another along a discrete portion of their respective lengths.

Embodiment 7: The ribbon cable of embodiment 5, wherein the substrate comprises a polymer layer.

Embodiment 8: The ribbon cable of embodiment 7, wherein the substrate comprises a polyimide layer.

Embodiment 9: The ribbon cable of embodiment 5, wherein the substrate comprises a ceramic layer.

Embodiment 10: The ribbon cable of embodiment 9, wherein the substrate comprises silicon carbide layer.

Embodiment 11: The ribbon cable of embodiment 5, wherein the substrate comprises silicon carbide layer overlying a polyimide layer.

Embodiment 12: The ribbon cable of embodiment 1, wherein the ribbon cable may be stretchable to at least 150% of its length down the central longitudinal (x) axis, such as at least 170%, such as at least 190%, such as at least 200%, such as at least 210%, or such as at least 220% of its length down the central longitudinal (x) axis.

Embodiment 13: The ribbon cable of embodiment 1, wherein the ribbon cable maintains an electrical connection along its length when stretched.

Embodiment 14: The ribbon cable of embodiment 1, wherein the ribbon cable is bendable about a radius of less than 1.2 mm while maintaining an electrical connection along its length when bent.

Embodiment 15: The ribbon cable of embodiment 1, wherein the stretchable electrically conductive material portion has a width in the lateral (y) direction, wherein the width is between 1 and 15 μm.

Embodiment 16: The ribbon cable of embodiment 1, wherein the at least one stretchable electrically conductive material portion comprises at least 4 stretchable electrically conductive material portions, such as at least 8 stretchable electrically conductive material portions, or such as at least 16 stretchable electrically conductive material portions.

Embodiment 17: The ribbon cable of embodiment 1, wherein the ribbon body further comprises at least one pad on at least one end of the ribbon cable body down the central longitudinal (x) axis.

Embodiment 18: The ribbon cable of embodiment 17, wherein the pad comprises a plurality of trace ends for electrically connecting the ribbon cable to a neighboring component.

Embodiment 19: The ribbon cable of embodiment 18, wherein at least one of the plurality of trace ends is electrically connected to at least one stretchable electrically conductive material portion.

Embodiment 20: The ribbon cable of embodiment 1, wherein the ribbon cable is implantable upon a biological substrate.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A ribbon cable comprising:
a ribbon cable body in a longitudinal (x), lateral (y) and transversal (z) dimensional axis system comprising a length down a central longitudinal (x) axis, wherein the ribbon cable body comprises at least one stretchable electrically contraconductive material portion along at least a portion of the length, wherein the stretchable electrically conductive material portion is oriented in a substantially flat accordion pattern in an longitudinal (x)/lateral (y) plane down the central axis, wherein the stretchable electrically conductive material portion is capable of re-orienting out of the longitudinal (x)/lateral (y) plane into the traversal (z) dimension when stretched in the longitudinal (x)/lateral (y) plane.

2. A method comprising:
providing a ribbon cable comprising a ribbon cable body in a longitudinal (x), lateral (y) and transversal (z) dimensional axis system comprising a length down a central longitudinal (x) axis, wherein the ribbon cable body comprises at least one stretchable electrically conductive material portion along at least a portion of the length, wherein the stretchable electrically conductive material portion is oriented in a substantially flat accordion pattern in a longitudinal (x)/lateral (y) plane down the central axis; and
stretching the stretchable electrically conductive material portion in the longitudinal (x)/lateral (y) plane to re-orient the stretchable electrically conductive material portion out of longitudinal (x)/lateral (y) plane into the traversal (z) dimension.

3. The ribbon cable of claim 1, wherein the stretchable electrically conductive material portion comprises a material selected from the group comprising at least one of copper, silver, gold and aluminum.

4. The ribbon cable of claim 1, wherein the accordion pattern comprises a plurality of stretchable electrically conductive material portions each having a zig-zag pattern oriented substantially parallel down the central longitudinal (x) axis.

5. The ribbon cable of claim 1, wherein the ribbon cable body further comprises a substrate, wherein the stretchable electrically conductive material portion is formed on or embedded within the substrate along at least a portion of a length of the stretchable electrically conductive material portion.

6. The ribbon cable of claim 5, wherein at least two of the plurality of stretchable electrically conductive material portions having a zig-zag pattern are each formed on or embedded within a first substrate portion and a second substrate portion respectively, wherein the first substrate portion and the second substrate portion each have a respective length, wherein the first substrate portion and the second substrate portion contact one another along a discrete portion of their respective lengths.

7. The ribbon cable of claim 5, wherein the substrate comprises a polymer layer.

8. The ribbon cable of claim 7, wherein the substrate comprises a polyimide layer.

9. The ribbon cable of claim 5, wherein the substrate comprises a ceramic layer.

10. The ribbon cable of claim 9, wherein the substrate comprises silicon carbide layer.

11. The ribbon cable of claim 5, wherein the substrate comprises silicon carbide layer overlying a polyimide layer.

12. The ribbon cable of claim 1, wherein the ribbon cable may be stretchable to at least 150% of its length down the central longitudinal (x) axis, such as at least 170%, such as at least 190%, such as at least 200%, such as at least 210%, or such as at least 220% of its length down the central longitudinal (x) axis.

13. The ribbon cable of claim 1, wherein the ribbon cable maintains an electrical connection along its length when stretched.

14. The ribbon cable of claim 1, wherein the ribbon cable is bendable about a radius of less than 1.2 mm while maintaining an electrical connection along its length when bent.

15. The ribbon cable of claim 1, wherein the stretchable electrically conductive material portion has a width in the lateral (y) direction, wherein the width is between 1 and 15 μm.

16. The ribbon cable of claim 1, wherein the at least one stretchable electrically conductive material portion comprises at least 4 stretchable electrically conductive material portions, such as at least 8 stretchable electrically conductive material portions, or such as at least 16 stretchable electrically conductive material portions.

17. The ribbon cable of claim 1, wherein the ribbon body further comprises at least one pad on at least one end of the ribbon cable body down the central longitudinal (x) axis.

18. The ribbon cable of claim 17, wherein the pad comprises a plurality of trace ends for electrically connecting the ribbon cable to a neighboring component.

19. The ribbon cable of claim 18, wherein at least one of the plurality of trace ends is electrically connected to at least one stretchable electrically conductive material portion.

20. The ribbon cable of claim 1, wherein the ribbon cable is implantable upon a biological substrate.
